(19) United States
(12) Patent Application Publication
(10) Pub. No.: US 2023/0177236 A1
(43) Pub. Date: Jun. 8, 2023

(54) METHOD AND DEVICE FOR CALCULATING SOLAR RADIATION NUMERICAL DATA BASED ON FIXED SLOPE ANGLE

(71) Applicant: National Institute of Meteorological Sciences, Seogwipo-si (KR)

(72) Inventors: Jinah YUN, Seogwipo-si (KR); Hee Wook CHOI, Seogwipo-si (KR); Yeon Hee KIM, Daejeon (KR)

(73) Assignee: National Institute of Meteorological Sciences, Seogwipo-si (KR)

(21) Appl. No.: 18/057,007

(22) Filed: Nov. 18, 2022

(30) Foreign Application Priority Data
Dec. 7, 2021 (KR) 10-2021-0173766

(51) Int. Cl. G06F 30/20

(52) U.S. Cl. CPC G06F 30/20; G06F 2111/10

(57) ABSTRACT

The present disclosure relates to a method and device for calculating solar radiation numerical data based on a fixed slope angle. A method of calculating solar radiation numerical data based on a fixed slope angle according to an embodiment of the present disclosure includes receiving solar radiation numerical data, removing an existing terrain effect from the solar radiation numerical data and applying detailed terrain information with a 100 m resolution to the solar radiation numerical data, applying a fixed slope angle to the detailed terrain information to calculate a global radiation, and dividing the global radiation on the basis of at least one of a grid, a season, a month, a time of day, and a fixed slope angle to generate average data.

### CROSS-REFERENCE TO RELATED APPLICATION(S)

This application claims priority from Korean Patent Application No. 10-2021-0173766, filed on Dec. 7, 2021, in the Korean Intellectual Property Office, the disclosure of which is incorporated herein by reference in its entirety.

### BACKGROUND

### 1. Field

The present disclosure relates to a method of calculating solar radiation numerical data based on a fixed slope angle, and more particularly, to a method and device for calculating solar radiation numerical data in consideration of a fixed slope angle according to a detailed terrain effect.

### 2. Description of Related Art

In general, in order to collect meteorological data for solar power generation, it is most appropriate to have observation equipment in a corresponding area and actually measure the meteorological data. However, in the case of solar radiation data based on observation data, there is a difficulty in calculating solar radiation data for points that cannot be observed or points desired by a user in addition to time and cost problems. Accordingly, grid-based solar radiation numerical data based on a high-accuracy numerical model is required.

In addition, since an output of a photovoltaic module is greatly affected by an angle between the photovoltaic module and the sunlight as well as an output of the sunlight itself, it is most important to accurately position an installation angle or orientation of the photovoltaic module at an optimal slope angle and optimal azimuth angle for each area so that a light-receiving surface of the photovoltaic module receives a maximum amount of solar radiation. In the case of Korea, since the solar altitude varies according to the seasons, it is required to measure solar radiation numerical data for each slope angle that further considers the daily change by season and time of day.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure has been made in response to the above-described necessity, and the present disclosure provides a method and device for accurately calculating solar radiation numerical data for each slope angle at each point by applying a fixed slope angle to a post-processing system based on high-resolution numerical data to which a detailed terrain effect is applied.

The technical objects of the present disclosure are not limited to those described above, and other technical objects that are not described herein may be clearly understood by those skilled in the art from the following descriptions.

In order to solve the above-described object, a method of calculating solar radiation numerical data based on a fixed slope angle according to an embodiment of the present disclosure includes receiving solar radiation numerical data, removing an existing terrain effect from the solar radiation numerical data and applying detailed terrain information with a 100 m resolution to the solar radiation numerical data, applying a fixed slope angle to the detailed terrain information to calculate a global radiation, and dividing the global radiation on the basis of at least one of a grid, a season, a month, a time of day, and a fixed slope angle to generate average data.

In order to solve the above-described object, a device for calculating solar radiation numerical data based on a fixed slope angle according to an embodiment of the present disclosure includes a data reception unit configured to receive solar radiation numerical data, a terrain information application unit configured to remove an existing terrain effect from the solar radiation numerical data and apply detailed terrain information with a 100 m resolution to the solar radiation numerical data, and a global radiation calculation unit configured to calculate a global radiation by applying a fixed slope angle to the detailed terrain information and generate average data by dividing the global radiation on the basis of at least one of a grid, a season, a month, a time of day, and a fixed slope angle.

Specific details of other embodiments are included in the detailed description and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart for describing a method of calculating solar radiation numerical data based on a fixed slope angle according to an embodiment of the present disclosure;

FIG. 2 a view intuitively showing a process of calculating solar radiation numerical data based on a fixed slope angle according to an embodiment of the present disclosure; and

FIG. 3 is a diagram for describing a device for calculating solar radiation numerical data based on a fixed slope angle according to an embodiment of the present disclosure.

### DETAILED DESCRIPTION

Advantages and features of the present disclosure and methods of achieving the same will be clearly understood with reference to the accompanying drawings and embodiments described in detail below. However, the present disclosure is not limited to the embodiments to be disclosed below, but may be implemented in various different forms. The embodiments are provided in order to fully explain the present disclosure and fully explain the scope of the present disclosure for those skilled in the art. The scope of the present disclosure is only defined by the appended claims.

In the drawings, like numbers refer to the same or like components, and all combinations described in the specification and claims may be made in any manner. A component referred to in the singular may include one or more components unless otherwise specified, and it should be understood that the singular forms are intended to include the plural forms as well.

The terminology used herein is for the purpose of describing specific exemplary embodiments only and is not intended to limit the present disclosure. As used herein, singular expressions may also be intended to include plural meanings unless the sentence clearly indicates otherwise. The term “and/or” includes any and all combinations of the items listed therewith. It should be further understood that the terms “comprise,” “comprising,” “include,” and/or “including” have an implicit meaning. Accordingly, these terms specify the described features, integers, steps, operations, elements, components, and/or groups thereof but do not preclude the presence or addition of one or more other features, integers, steps, operations, elements, components, and/or groups thereof.

The steps, processes, and operations of the method described herein should not be construed as necessarily performing their performance in such a specific order as discussed or exemplified, unless specifically determined to be an order of performance thereof. It should also be understood that additional or alternative steps may be used.

In addition, each of the components may be implemented as a hardware processor, the above components may be integrated into one hardware processor, or the above components may be combined with each other and implemented as a plurality of hardware processors.

Before describing embodiments of the present disclosure, terms used in the present disclosure will be briefly described.

Spatial resolution: Spatial resolution refers to a distance between grid points that represent the atmosphere suitable for computer calculations, that is, a spatial scale (several hundreds of meters to several hundreds of kilometers) represented by grid points, and is also called horizontal resolution. Excellent spatial resolution means that the size of the grid points is small.

Solar radiation: Solar radiation refers to an amount of radiant energy of the sun that reaches the ground and varies with latitude. Solar radiation is measured by measuring an amount of sunlight radiated for 1 minute in an area of 1 cm² perpendicular to the traveling direction of the sunlight. The unit of the solar radiation is watt per square meter (W/m²). Solar radiation measured at the earth's surface is only 70% of that measured outside the atmosphere. This is because the sun's radiant energy is reduced by absorption or scattering caused by dust or water vapor that occurs in the air. Solar radiation is classified into global radiation, direct solar radiation, and scattered solar radiation according to a measurement method.

Global radiation: Global radiation is the sum of direct solar radiation and sky (scattered) solar radiation that are incident on a horizontal plane. cal/cm²·min or W/m² is used as the unit for expressing the amount of energy. Global radiation is calculated by adding scattered solar radiation to a value obtained by multiplying direct solar radiation by a solar zenith angle (cos).

Direct solar radiation: Direct solar radiation refers to solar radiation that reaches the earth's surface directly from the sun without being absorbed and scattered by water vapor or small dust in the atmosphere. In other words, direct solar radiation refers to the amount of solar radiation that reaches a plane perpendicular to the sun on the earth's surface. Direct solar radiation represents the amount of solar radiation received by a unit area of the surface per unit time.

Scattered solar radiation: Scattered solar radiation refers to the amount of solar radiation scattered in various directions by colliding with air molecules or suspended particles in the atmosphere.

Sky view factor (SVF): An SVF is a major factor that quantifies the influence of obstacles that obscure the sky and explains a relationship between the complex geometric characteristics of the city and the urban heat island (UHI).

Hereinafter, a method and device for calculating solar radiation numerical data based on a fixed slope angle according to embodiments of the present disclosure will be described with reference to the accompanying drawings.

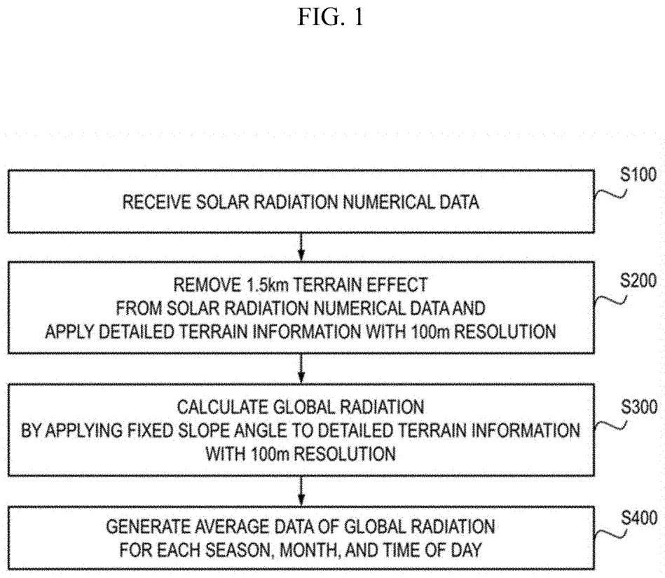

FIG. 1 is a flowchart for describing a method of calculating solar radiation numerical data based on a fixed slope angle according to an embodiment of the present disclosure. Referring to FIG. 1, in the method of the present disclosure, solar radiation numerical data may be calculated by applying a fixed slope angle to high-resolution solar radiation numerical data to which a detailed terrain effect is applied.

Solar radiation is greatly affected not only by weather information at a corresponding point, but also by a shadow shielding effect caused by the surrounding terrain. However, since a conventionally used solar radiation numerical model tends to over- or under-simulate a terrain effect, high-resolution terrain data should be reflected.

Since Korean topography consists of complex terrain conditions with various azimuth angles of 0 to 360 degrees and various slope angles of about 0 to 36 degrees, it is essential to use high-accuracy solar radiation numerical data reflecting high-resolution terrain data. The solar radiation numerical data is based on an altitude, an azimuth angle, a slope angle, and an SVF, and thus an influence of the surrounding terrain such as a shadow shielding effect or the like may be reflected in the solar radiation numerical data.

According to the method of the present disclosure, first, solar radiation numerical data may be received in order to calculate solar radiation numerical data based on a fixed slope angle (S100). The solar radiation numerical data may include analysis data of direct solar radiation and scattered solar radiation with a 1.5 km spatial resolution of a local data assimilation and prediction system (LDAPS) currently used by the Korea Meteorological Administration. By dividing a map for an information provision target area into grids of a preset size, the solar radiation numerical data may be divided solar radiation information for each grid and time.

The high-resolution solar radiation numerical data used in the method of the present disclosure is based on Korea Meteorological Administration Post-Processing (KMAPP), which is a scale-detailed numerical data calculation system. Specifically, the KMAPP reflects a detailed terrain effect by applying high-resolution terrain data to the LDAPS used by the Korea Meteorological Administration, and produces high-resolution solar radiation information through a scale detailing technique specialized for solar radiation data.

After operation S100, detailed terrain information with a 100 m resolution may be applied after removing a 1.5 km terrain effect from the high-resolution solar radiation numerical data (S200).

Specifically, the solar radiation numerical data received in operation S100 includes analysis data of direct solar radiation and scattered solar radiation with a 1.5 km spatial resolution. Therefore, in operation S200, the 1.5 km terrain effect that is applied to the direct solar radiation and scattered solar radiation for each grid with a 1.5 km spatial resolution may be removed from the received solar radiation numerical data.

The terrain effect described in the present disclosure includes an altitude, a slope angle, an azimuth angle, and an SVF. Therefore, in order to remove the 1.5 km terrain effect that is applied to the direct solar radiation and scattered solar radiation of the 1.5 km terrain effect included in the solar radiation numerical data received in operation S100, a first direct solar radiation Ks and a first scattered solar radiation D_{S} of the solar radiation numerical data may be converted into a second direct solar radiation K_{H} and a second scattered solar radiation DH reaching a horizontal surface (Equation 1). A terrain effect F_{K} of the second direct solar radiation K_{H} and a terrain effect F_{D} of the second scattered solar radiation DH that are used in the conversion process may be calculated through Equation 2.

In Equation 2, β denotes a terrain slope angle of each grid, ζ denotes a solar azimuth angle, c denotes a solar incidence angle, and ψ denotes a perforation ratio of each grid. ψ may be calculated from a horizontal angle H of each grid.

The solar incidence angle c in Equation 2 may be calculated through Equation 3. In Equation 3, φ denotes a solar azimuth angle, and γ denotes an azimuth angle of a terrain inclined surface.

$${K}_{H} = {K}_{S} / {F}_{K} , {D}_{H} = {D}_{S} / {F}_{D} \qquad [ Equation 1 ]$$

$${F}_{K} = \frac{cos c}{cos β \cdot cos ζ} , {F}_{D} = \frac{ψ}{cos β} \qquad [ Equation 2 ]$$

$$cos c = cos β \cdot cos ζ + sin β \cdot sin ζ \cdot cos ( ϕ - γ ) \qquad [ Equation 3 ]$$

The method of the present disclosure may remove the 1.5 km terrain effect from the solar radiation numerical data through Equation 1 to Equation 3, and then generate solar radiation numerical data at 100 m intervals by performing a linear interpolation method on the solar radiation numerical data (direct solar radiation and scattered solar radiation) without a terrain effect.

The method of the present disclosure may generate detailed terrain information with a 100 m resolution by applying a terrain effect of a 100 m resolution to the solar radiation numerical data at 100 m intervals. The terrain effect of the 100 m resolution used in the method of the present disclosure is based on shuttle radar topography mission (SR™) data. SR™ is a project to build a global topography model using satellites. Currently, in the United States, a terrain model with a precision of 30 m×30 m has been established. Outside the United States, terrain models with a precision of 90 m×90 m have been established.

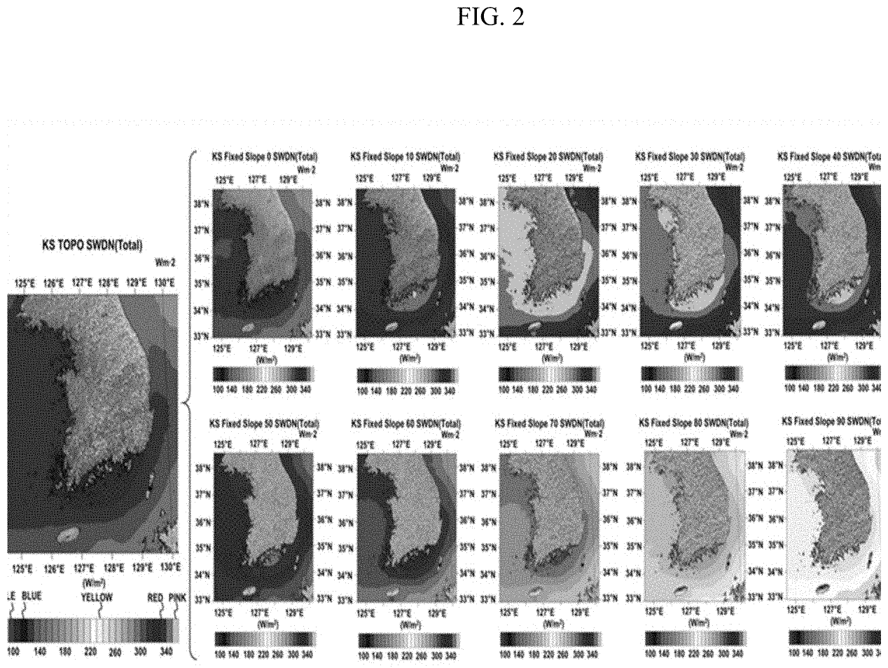

After operation S200, the direct solar radiation and the scattered solar radiation may be calculated by applying a fixed slope angle to the detailed terrain information with the 100 m resolution to calculate global radiation (S300). Global radiation is the sum of direct solar radiation and sky (scattered) solar radiation incident on a horizontal plane, and cal/cm² min or W/m² is used as the unit of the global radiation representing the amount of energy. In the method of the present disclosure, the global radiation for each fixed slope angle may be calculated by arbitrarily apply a fixed slope angle (0 to 90 degrees). The global radiation for each fixed slope angle calculated in operation S300 is as shown in FIG. 2.

In the case of the global radiation, as the slope angle increases, the effect on the azimuth angle is maximized, and thus a difference in solar radiation will be clearly exhibited according to the azimuth angle like that the solar radiation is high in the south-facing series and the solar radiation is low in the north-facing series, etc.

In the method of the present disclosure, since the solar radiation numerical data, which is basic data for calculating the global radiation, provides solar radiation information for each grid and time, the global radiation may also be classified by the grid and time, and furthermore, may be classified by the fixed slope angle.

Since there are four distinct seasons in Korea so that a change in solar altitude for each season is large, solar radiation numerical data for each fixed slope angle that considers all of seasonal, hourly, and daily changes is required. Accordingly, the method of the present disclosure may generate average data of the global radiation for each season, month, and time of day on the basis of the global radiation for each grid, time, and fixed slope angle calculated in operation S300 (S400).

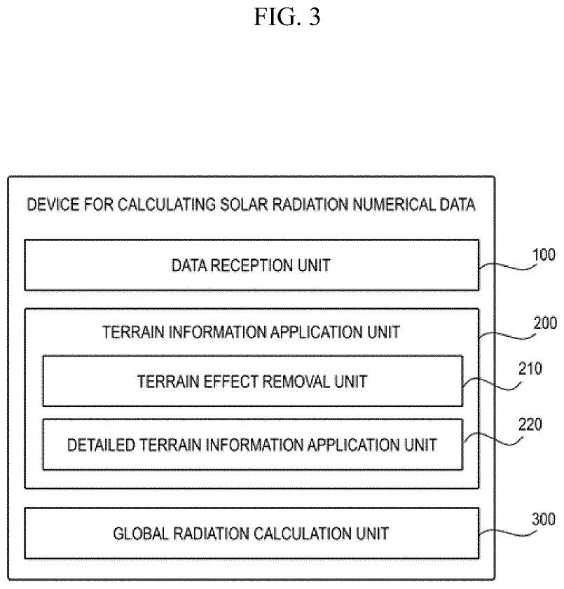

FIG. 3 is a diagram for describing a device for calculating solar radiation numerical data based on a fixed slope angle according to an embodiment of the present disclosure. Hereinafter, the device for calculating solar radiation numerical data based on a fixed slope angle will be described with reference to FIG. 3. In description of the device for calculating solar radiation numerical data based on a fixed slope angle, a description of a detailed embodiment identical to that of the method of calculating solar radiation numerical data based on a fixed slope angle described above may be omitted.

A data reception unit 100 may receive solar radiation numerical data to calculate solar radiation numerical data based on a fixed slope angle. The solar radiation numerical data may include analysis data of direct solar radiation and scattered solar radiation with a 1.5 km spatial resolution of an LDAPS currently used by the Korea Meteorological Administration. By dividing a map for an information provision target area into grids of a preset size, the solar radiation numerical data may be divided solar radiation information for each grid and time.

A terrain information application unit 200 removes a 1.5 km terrain effect from the solar radiation numerical data to reflect detailed terrain information with a 100 m resolution. Specifically, the terrain information application unit 200 may include a terrain effect removal unit 210 and a detailed terrain information application unit 220.

The solar radiation numerical data includes the analysis data of the direct solar radiation and scattered solar radiation with the 1.5 km spatial resolution. Therefore, the terrain effect removal unit 210 may remove the 1.5 km terrain effect that is applied to the direct solar radiation and the scattered solar radiation for each grid with a 1.5 km spatial resolution.

When the terrain effect removal unit 210 removes the 1.5 km terrain effect from the solar radiation numerical data, the detailed terrain information application unit 220 may calculate solar radiation numerical data at 100 m intervals by performing a linear interpolation method on the solar radiation numerical data (direct solar radiation and scattered solar radiation) without a terrain effect. The detailed terrain information application unit 220 may generate detailed terrain information with a 100 m resolution by applying a terrain effect with a 100 m resolution to the solar radiation numerical data at 100 m intervals.

A global radiation calculation unit 300 may calculate the direct solar radiation and the scattered solar radiation by applying a fixed slope angle to the detailed terrain information with the 100 m resolution to calculate a global radiation. The global radiation calculation unit 300 may apply an arbitrary fixed slope angle (0 to 90 degrees) to calculate the global radiation for each fixed slope angle.

Since the solar radiation numerical data, which is the basic data for calculating the global radiation of the present disclosure, is provided for each grid and time, the global radiation may also be classified by the grid and time, and furthermore, may be classified by the fixed slope angle.

Since there are four distinct seasons in Korea so that a change in solar altitude for each season is large, the solar radiation numerical data based on the fixed slope angle that considers all of seasonal, hourly, and daily changes is required. Accordingly, the global radiation calculation unit 300 may generate average data of the global radiation for each season, month, and time of day on the basis of the calculated global radiation for each grid, time, and fixed slope angle.

As described above, the method and device for calculating the solar radiation numerical data based on the fixed slope angle according to embodiments of the present disclosure have been described. The disclosed embodiments may be implemented in the form of a recording medium configured to store instructions executable by a computer. The instructions may be stored in the form of program code. When the instructions are executed by a processor, the operations of the disclosed embodiments may be performed by a program module being generated thereby. The recording medium may be implemented as a computer-readable recording medium.

The computer-readable recording media include any type of recording media in which computer-decodable instructions are stored. For example, examples of the computer-readable recording media may include a read only memory (ROM), a random-access memory (RAM), a magnetic tape, a magnetic disk, a flash memory, an optical data storage device, and the like.

The computer-readable storage medium may be provided in the form of a non-transitory storage medium. Here, the “non-transitory storage medium” is a tangible device and only means that the storage medium does not include a signal (e.g., electromagnetic wave), and this term does not distinguish that data is semi-permanently or temporarily stored in the storage medium. For example, the “non-transitory storage medium” may include a buffer in which data is temporarily stored.

The methods according to various embodiments disclosed in this specification may be provided by being included in computer program products. The computer program products may be traded between sellers and buyers as commodities. The computer program products may be distributed in the form of a computer-readable storage medium (e.g., compact disc read only memory (CD-ROM)), online (e.g., download or upload) through an application store (e.g., Play Store™), or directly between two user devices (e.g., smartphones). In the case of online distribution, at least some of the computer program products (e.g., downloadable app) may be temporarily stored or temporarily generated in a storage medium such as a memory of a server of a manufacturer, a server of an application store, or a relay server.

According to embodiments of the present disclosure, by applying a fixed slope angle to a post-processing system based on high-resolution numerical data to which a detailed terrain effect is applied, it is possible to more accurately calculate solar radiation numerical data for each slope angle at each grid point.

According to embodiments of the present disclosure, in order to efficiently use solar energy, such as identifying optimal installation conditions when a fixed/tracking photovoltaic module is installed and estimating maximum efficiency in the photovoltaic module, it is possible to utilize solar radiation numerical data for each slope angle.

Effects of the present disclosure are not limited to the above-described effects and other effects that are not described may be clearly understood by those skilled in the art from the above detailed descriptions.

The embodiments of the present disclosure have been described above with reference to the accompanying drawings. It should be understood by those skilled in the art that the present disclosure may be embodied in forms different from the disclosed embodiments without departing from the scope of the present disclosure and without changing essential features thereof. Therefore, the above-described embodiments should be considered in a descriptive sense only and not for purposes of limitation.

What is claimed is:

1. A method of calculating solar radiation numerical data based on a fixed slope angle, the method comprising:
receiving solar radiation numerical data;
removing an existing terrain effect from the solar radiation numerical data and applying detailed terrain information with a 100 m resolution to the solar radiation numerical data;
applying a fixed slope angle to the detailed terrain information to calculate a global radiation; and
dividing the global radiation on the basis of at least one of a grid, a season, a month, a time of day, and a fixed slope angle to generate average data.

2. The method of claim 1, wherein the solar radiation numerical data is based on Korea Meteorological Administration Post-Processing (KMAPP) to which a scale detailing technique is applied.

3. The method of claim 1, wherein the solar radiation numerical data includes a first direct solar radiation and a first scattered solar radiation having a 1.5 km spatial resolution.

4. The method of claim 3, wherein the applying includes removing the existing terrain effect of a 1.5 km resolution from the solar radiation numerical data by converting the first direct solar radiation and the first scattered solar radiation that reach an inclined surface to a second direct solar radiation and a second scattered solar radiation that reach a horizontal surface, respectively.

5. The method of claim 4, wherein the applying further includes
calculating solar radiation numerical data at 100 m intervals by applying a linear interpolation method to the solar radiation numerical data from which the existing terrain effect is removed; and
generating the detailed terrain information with a 100 m resolution by applying a terrain effect with a 100 m resolution to the solar radiation numerical data at 100 m intervals.

6. The method of claim 1, wherein the fixed slope angle is arbitrarily selected from between 0 degrees to 90 degrees.

7. A device for calculating solar radiation numerical data based on a fixed slope angle, comprising:
a data reception unit configured to receive solar radiation numerical data;
a terrain information application unit configured to remove an existing terrain effect from the solar radiation numerical data and apply detailed terrain information with a 100 m resolution to the solar radiation numerical data; and
a global radiation calculation unit configured to calculate a global radiation by applying a fixed slope angle to the detailed terrain information and generate average data by dividing the global radiation on the basis of at least one of a grid, a season, a month, a time of day, and a fixed slope angle.

8. A non-transitory computer-readable recording medium for storing instructions, wherein the instructions cause one or more processors to:
receive solar radiation numerical data;
remove an existing terrain effect from the solar radiation numerical data and apply detailed terrain information with a 100 m resolution to the solar radiation numerical data;
calculate a global radiation by applying a fixed slope angle to the detailed terrain information; and
generate average data by dividing the global radiation on the basis of at least one of a grid, a season, a month, a time of day, and a fixed slope angle.
